(19) United States
(12) Patent Application Publication
(10) Pub. No.: US 2012/0096724 A1
(43) Pub. Date: Apr. 26, 2012

(54) CUT OUT TEMPLATE

(76) Inventors: John Eyermann, Ballwin, MO (US); Peter Vrame, Wood Dale, IL (US)

(21) Appl. No.: 13/282,027

(22) Filed: Oct. 26, 2011

Related U.S. Application Data
(60) Provisional application No. 61/455,777, filed on Oct. 26, 2010.

(51) Int. Cl. G01B 1/00; G01C 9/24

(52) U.S. Cl. 33/354

(57) ABSTRACT

A cut out template device is provided which enables fast installation of electrical boxes and devices by allowing for improved alignment and location. The cut out template includes a cavity having a size and shape approximating the size and shape of the electrical box and at least one leveler bubble for ensuring the template is level in either the horizontal or vertical direction.

### CROSS-REFERENCE TO RELATED APPLICATION

This application claims the benefit of U.S. Provisional Patent Application No. 61/455,777, entitled “Cut Out Template,” filed Oct. 26, 2010.

### FIELD OF THE INVENTION

The present device relates to a cut out template for alignment of electrical boxes and devices. Particularly, the present device relates to a template that allows for fast vertical and horizontal alignment of boxes and devices while minimizing damage to drywall.

### BACKGROUND

In the typical construction or remodeling of a building structure, electrical wiring is accessed through electrical boxes such as outlet boxes, junction boxes, and electrical switches. These boxes, as well as other devices, typically provide access to electrical wiring through a hole in the wall, ceiling, or other surface. Often the boxes are installed at a uniform distance from the floor or at a uniform distance from some other structure. For aesthetic reasons, it is often desirable that the boxes be installed in a level orientation.

Previously, installation of boxes in a level orientation required the use of a separate bubble level or other leveling device when cutting the hole into the wall into which the box would be inserted. Additionally, in order to properly position the box in the wall, the centerline of the hole would need to be aligned in the proper location. As such, the installation could be very time consuming, and if the worker is not skilled, mistakes may cause the hole to be sized, located, or aligned incorrectly.

The present application is directed to a cut out template with attached leveler bubbles to ensure the box and device are substantially level when installed in either a horizontal or vertical position. The cut out template also has centerline marks to help assist in positioning the template in the proper location on the wall. The cut out template also has clearance holes for screw heads in the box.

### SUMMARY OF THE INVENTION

A cut out template is provided. In one form, the template contains a cavity that is of substantially the same size and shape as the box or device to be inserted in the drywall or other surface. The template includes a first leveler bubble attached to the template. The first leveler bubble is used to ensure that the box and device is substantially level when installed in a horizontal position. The template also includes a second leveler bubble attached to the template. The second leveler bubble is used to ensure that the box and device is substantially level when installed in a vertical position. In the illustrated embodiment, the leveler bubbles are locked into place using a snap fit in the template.

In another form, the cavity may further include indentations indicating the centerline for both horizontal and vertical orientations to assist in the proper location of the template on the drywall or other surface.

These and other aspects may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a top view of a cut out template;

FIG. 2 is a cross-sectional view of a portion of the cut out template in FIG. 1.

### DETAILED DESCRIPTION

While this device is susceptible of embodiments in many different forms, there is shown in the drawings and will herein be described in detail a preferred embodiment of the device with the understanding that the present disclosure is to be considered as an exemplification of the principles of the device and is not intended to limit the broad aspect of the device to embodiments illustrated.

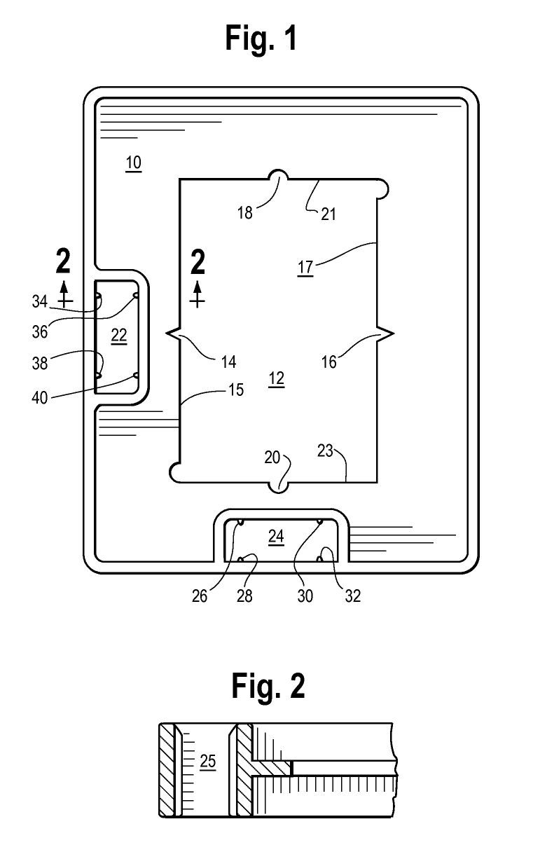

Referring to FIG. 1, there is illustrated a cut out template, generally designated by the numeral 10. The cut out template 10 has a cavity 12 of the approximate size and shape of an electrical box or device. Centering indentations 14 and 16 are located on each vertical edge 15 and 17 of the cavity 12, preferably in the center of each edge 15 and 17 of the cavity 12. Centering indentations 18 and 20 are also located on each horizontal edge 21 and 23 of the cavity 12, preferably in the center of each edge 21 and 23 of the cavity 12. In the embodiment pictured, the horizontal indentations 18 and 20 are large enough to provide clearance holes 25 for the screw heads in the box or device (not shown).

Attached to the cut out template 10 are a leveler bubble 22 for the horizontal position and a leveler bubble 24 for the vertical position. In the embodiment pictured, the leveler bubbles 22 and 24 are locked to the cut out template 10 through the use of small tabs 26, 28, 30, 32, 34, 36, 38, and 40 in the cut out template. In the embodiment pictured, these tabs 26, 28, 30, 32, 34, 36, 38, and 40 are rounded with a length of approximately 0.045 inches and a width of approximately 0.04 inches. It will be appreciated that leveler bubbles 24 can be coupled to cut out template 10 through any means, including, for example, adhesive, tape, screws or rivets.

In one form, the cavity 12 measures approximate 2.00 inches across by approximately 3.12 inches high. In this form, the indentations 14 and 16 in the vertical edges 15 and 17 of the cavity 12 have a depth of approximately 0.03 inches, and are centered on the vertical edges 15 and 17 of the cavity 12. The indentations 18 and 20 in the horizontal edges 21 and 23 of the cavity 12 are semi-circular with an approximate 0.18R(4) size to allow clearance for screw heads.

In one form, the cut out template 10 is made out of transparent polycarbonate plastic. In this form, the cut out template 10 is durable, lightweight, and can easily be carried in a conventional tool belt or tool box.

In one use, the user measures the desired distance from the floor and from a side measurement location. The user then positions the cut out template such that these measurements substantially align with the centering indentations 14, 16, 18, and 20. The user can position the cut out template 10 in either the horizontal or vertical alignment using these measurements. The user then rotates the cut out template 10 such that the leveler bubble 22 for the horizontal position or the leveler bubble 24 for the vertical position indicates that the template 10 is substantially level. The user then traces with a pencil, pen, or other means around the template cavity 12. After removing the cut out template 10 from the wall, the user cuts out the material following the tracing, revealing a properly aligned hole for the box or device. Although a wall and floor are referenced, those skilled in the art will realize that any surface or reference point could be used where a box or device is desired.

In one use, the user can employ the cut out template 10 to cut a hole for a ganged electrical box or device by sliding the cut out template 10 along the centering lines in one or multiple directions and aligning the centering indentations 14, 16, 18, 20 with the previous measurements.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A cut out template for approximating a location of an electrical box having a size and shape, comprising:
a cavity, and
a first leveler bubble for leveling the template in a horizontal position.

2. The cut out template of claim 1, further comprising a second leveler bubble for leveling the template in a vertical position.

3. The cut out template of claim 1, further comprising indentations in the cavity.

4. The cut out template of claim 1, wherein the cavity has a size and shape approximate the size and shape of the electrical box.

5. The cut out template of claim 3, further comprising two horizontal edges and two vertical edges.

6. The cutout template of claim 5, wherein the indentations are generally located at center points of the two horizontal edges and the two vertical edges.

7. The cutout template of claim 6, wherein the indentations are adapted to permit clearance of a screw head.

8. The cutout template of claim 2, further comprising a coupling structure for retaining the first leveler bubble and the second leveler bubble.

9. The cutout template of claim 8, wherein the coupling structure is a locking tab.

10. The cutout template of claim 1, wherein the cutout template is composed of a plastic.

11. A cut out template for approximating location of an electrical box having a size and shape, comprising:
a cavity having a size and shape approximate the size and shape of the electrical box,
two horizontal edges and two vertical edges,
indentations in the cavity located at center points of the two horizontal edges and the two vertical edges,
a first leveler bubble for leveling the template in a horizontal position,
a second leveler bubble for leveling the template in a vertical position, and
a coupling structure for retaining the first leveler bubble and the second leveler bubble.
